(19) United States
(12) Patent Application Publication
(10) Pub. No.: US 2026/0080300 A1
(43) Pub. Date: Mar. 19, 2026

(54) FRAMEWORK FOR DEVELOPING PREDICTIVE ANALYTICS MODELS USING MACHINE LEARNING ALGORITHMS

(71) Applicant: Muhammad Rizwan Tahir, Mississauga (CA)

(72) Inventor: Muhammad Rizwan Tahir, Mississauga (CA)

(21) Appl. No.: 18/887,342

(22) Filed: Sep. 17, 2024

(51) Int. Cl. G06N 20/00

(52) U.S. Cl. CPC G06N 20/00

(57) ABSTRACT

A Framework for developing, training and deploying Predictive Analytics Models using Artificial Intelligence based Machine Learning algorithms is presented. The Framework is a collection of processes with User Interface and Data Processing components which interact with input data acquisition, output data visualization and data transmission systems. The key part of the Framework is automation of processes involved in building, training and deploying a model, with the aim of reducing the time and manual effort normally required in such tasks. The Framework also includes a proprietary method of machine learning algorithm selection process based on use case and certain characteristics of data, that ultimately results in improved accuracy of Predictive Analytics models for real time and non-real time applications.

### FIELD

The current endeavor relates to the field of Artificial Intelligence or AI, particularly the processes involved in developing, training and deploying Predictive Analytics models using Machine Learning Algorithms.

### BACKGROUND

Artificial Intelligence based Machine Learning Algorithms are used in Predictive Analytics Models to predict the outcome of a future event. The processes and methods involved in the branch of Predictive Analytics differ from other forms of Artificial intelligence problems such as Machine Vision, Speech Recognition, Natural Language Learning etc. Key elements in creating or developing Predictive Analytics models is selection of an algorithm and training the model to predict a future outcome accurately. Traditional methods involve trial and error experiments to determine which Machine Learning Algorithm would work best for a given problem scenario, which could result in significant manual effort and cost. Some studies have shown greater accuracy by using ensemble methods. Furthermore, the techniques and methods commercially available rely on advanced knowledge of Statistics, Programming Language such as Python or R and Data Science disciplines, which does not make such development platforms intuitive for a user having business domain knowledge but who may not be skilled in above mentioned technical disciplines to develop models programmatically.

### SUMMARY

By using a Framework that provides an intuitive model development user interface system and a collection of methods and processes to assist the user in selecting and training the most appropriate machine learning algorithm for predictive analytics, the manual effort involved in selecting, creating and training a model can be considerably reduced. Furthermore, using certain attributes of sample data and an ensemble of machine learning algorithms, the accuracy of the predictive analytics models can be further improved. The automation processes involved in the Framework aim to make the overall processes cost effective and efficient.

One embodiment of the Framework consists of single board computers as output devices.

Second embodiment of the Framework consists of display monitors as output devices.

Third embodiment of the Framework consists of both single board computers and display monitors as output devices.

In all embodiments, the Framework components are capable of interfacing with a variety of input data sources and the user interface may consist of either thin client-based web application components, windows desktop or mobile application components. However, the meaningful embodiment here is the delivery of real time predictive alerts through visual display output devices or special purpose single board computers responsible to act on an event of interest in real time.

Further features, processes, advantages and applications of the Framework are explained in detailed description section.

### BRIEF DESCRIPTION OF THE FIGURES, TABLES AND PROCESS FLOWCHARTS

The specification of individual processes, methods and components of the Framework is provided in detailed description section and references following figures, tables and flow charts:

FIG. 1 is an illustration of the Framework according to first embodiment,

FIG. 2 is an illustration of the Framework according to second embodiment,

FIG. 3 is an illustration of the Framework according to third embodiment,
Table 1 is in reference to first step in Algorithm Selection and Ranking Process,
Table 2 is in reference to second step in Algorithm Selection and Ranking Process, and
Flowchart 1 is in reference to the process flow of Algorithm Selection and Ranking.

### DETAILED DESCRIPTION

In the following sections, a detailed description of the Framework is provided using the embodiments and components within it, Also, each component is described with the help of illustration in the figures, references to the tables and flowchart. Where applicable, the processes associated with components are described with examples. It is important to note that the user interface part of the Framework as presented in each embodiment, could be developed in the form of a cloud-based web application or windows desktop application. Furthermore, the labels in the embodiment are not shown for external input data sources, as they are well understood technologies for making input data available, such as structured, unstructured, sensor and stream data-made available to the Framework for processing.

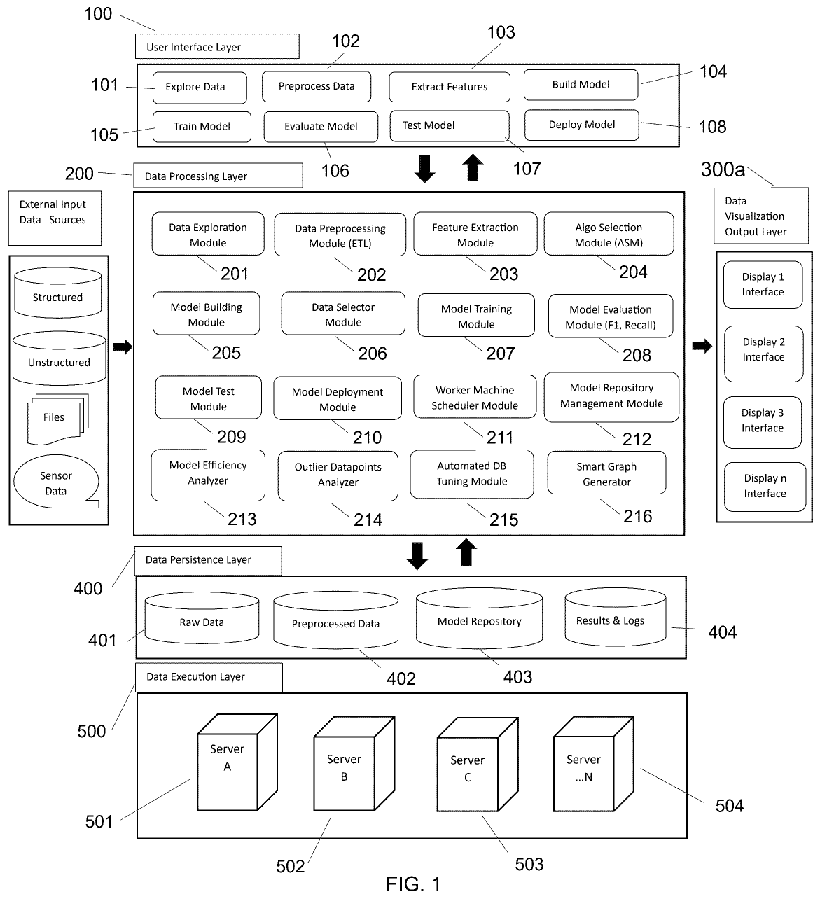

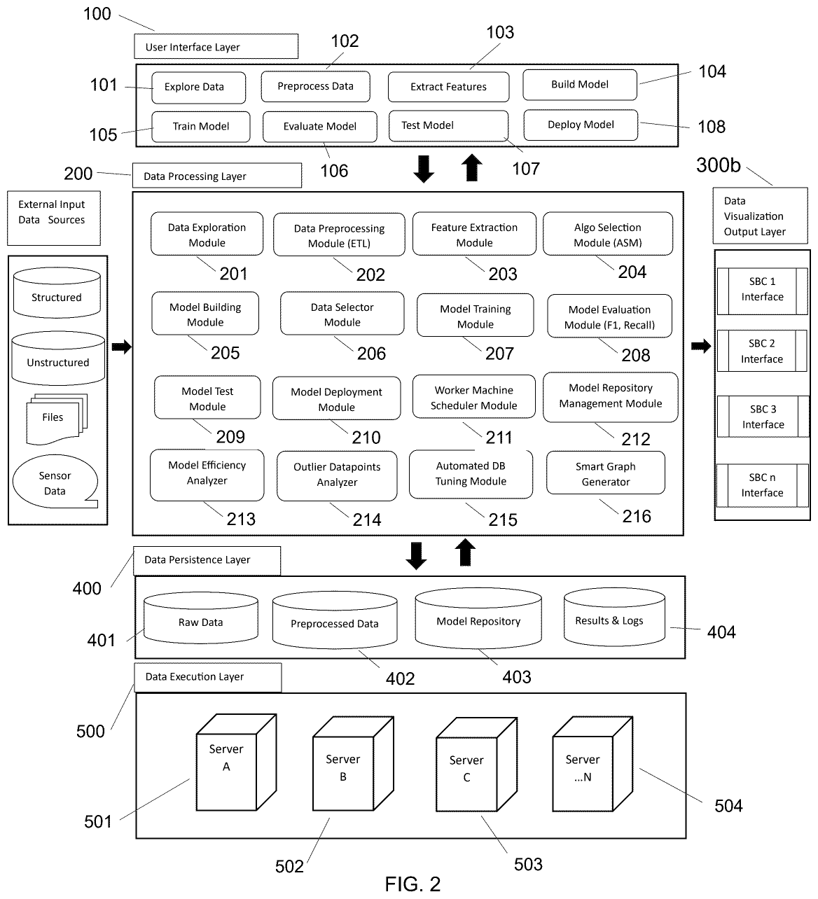

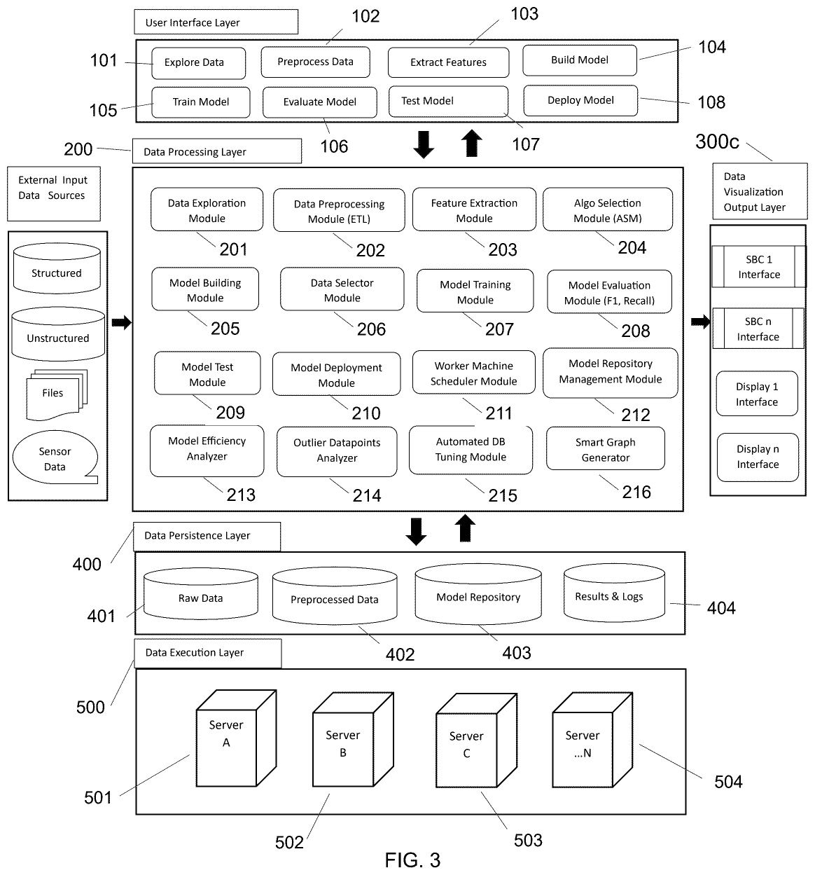

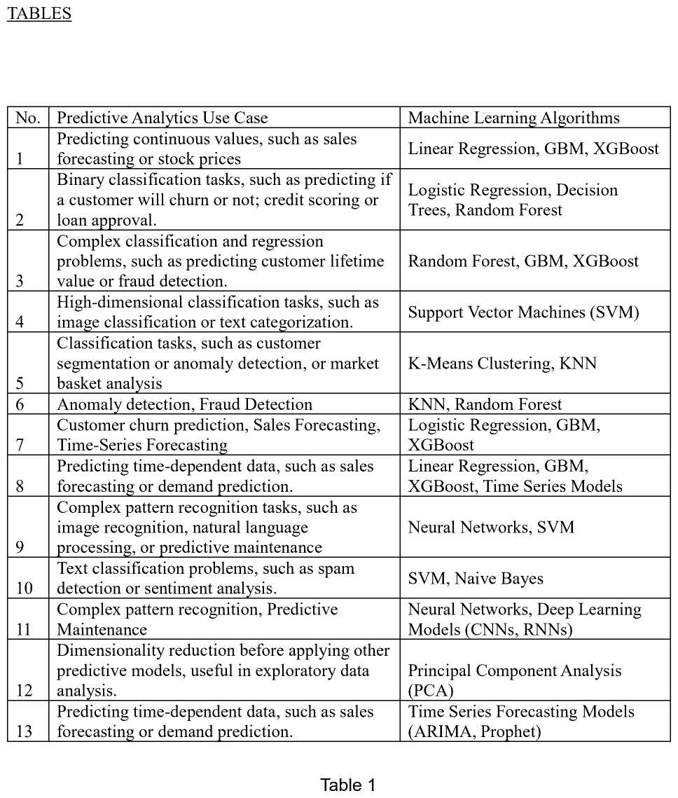

The first embodiment of the Framework is presented in FIG. 1. In this embodiment, the user Interface layer 100 comprises eight interfaces as illustrated in FIG. 1. These interfaces interact with processes embodied in Data Processing Layer 200 to perform appropriate actions on data. The Explore Data Module 101 provides user with the ability to explore input data to identify outliers, duplicates, null values, missing data. This interface interacts directly with Data Exploration Module 201, which contains methods to process and display data dynamically in both tabular and graphical format by inferring input data characteristics, number of dimensional and measurable attributes. These processes allow the user to understand structure and characteristics of data by inspecting them in visual elements which are automatically selected and displayed based on the data content as described above. The benefit of this approach is that the user does not need to manually select the type of graphical element to display dimensions and measures, which gets generated automatically using the interface control elements of module 101. The raw data can be persisted in Raw Data repository 401 in Data Persistence layer 400.

The Pre-process Data interface 102 in the user interface layer works together with the back-end Data Pre-processing Module 202, which effectively contains methods for ETL (Extract, Transform and Load) transformations. These processes facilitate for data cleanup and data preparation by removing duplicates and outlier values from input data. These processes also allow a user to separate sample data set into separate Training and Test Data Sets using a Data Selector Module 206 and corresponding controls in user interface element 102. Another feature of the interface 102 and process 202 is to produce a standardized format for input data from external data sources, so the data is presented in a consistent format to the user. The benefit of such an approach reduces the chance of wrong predictions when data is used in later processes of Model Evaluation 208 and Model Testing 209 processes. The pre-processed data persists in the Pre-processed Data repository 402.

The Extract Features interface 103 invokes processes in Feature Extraction Module 203, which allows a user to extract attributes of interest for building an analytical model. One advantage of this interface and process respectively is that it allows tagging attributes in the pre-processed data with greatest predicting power and creating derived attributes if necessary. Common methods used include Pearson Correlation or Chi-Square algorithm for feature selection with greatest predictive power.

Algorithm Selection Module (ASM) 204, together with Build Model interface 104, consists of processes and methods to automatically select an optimal algorithm for training a Predictive Analytics model. The model selection process follows a proprietary algorithm or method, which uses responses from user to determine the machine learning algorithm that aims to produce an efficient and optimal result for a given problem domain. The advantage of this approach of user driven model building process which relies on user responses to a series of questions about data characteristics is, that the user does not need to do trial and error runs by manually experimenting with each algorithm that might be applicable to the problem domain, which could take considerable time and effort. In this way, the Algorithm Selection Module (ASM) 204 acts as an Algorithm Recommender Engine that improves model selection process by making it efficient and automated. Furthermore, if the engine recommends ensemble of algorithms (two or more), then an automated calibration of normalization weights is performed until a ratio of weights is achieved that could produce the optimal predictive power.

To help understand this approach, consider a concrete example of this proprietary Algorithm recommendation process with the help of Tables 1 and 2, and Flow chart 1.

Suppose a user interacts with the Build Model interface 104 and answers a series of questions. Based on each question, an algorithm is recommended. The number of times an algorithm is cited becomes the significance score. An aggregate after all questions have been answered determines a list of algorithms ranked from highest to lowest score called “Algo-Rank”, thus forming a recommendation list for user to choose from. This is the proprietary method of arriving at an optimal algorithm to use for training the machine learning model. If two or more algorithms reach same score, then the process recommends an Ensemble method comprising of two of more algorithms to minimize the algorithm bias, as evidenced by studies done in the field of Machine Learning and AI. The user can make the final determination and can override the recommendation from the engine if he/she so wishes.

The novelty of this method is that not only it helps automate the process of narrowing down the algorithm selection process, which would otherwise require trial and error runs and several man hours, but it helps generate a significance score based on a mathematical approach of fairness and equal chance distribution. This approach strings together various elements of data characteristics, to produce a recommendation or significance score, which ultimately gives confidence to the user in making the right choice for training algorithm. This is illustrated in table below, where Random Forest is indicated to have the highest Significance score and thus the algorithm of choice ranking at number one.

| Algorithm Name | Significance-Score | Algo-Rank |
|---|---|---|
| Naïve Bayes | 4 | 3 |
| KNN | 5 | 2 |
| K-Means | 4 | 3 |
| GMM | 1 | 4 |
| Random Forest | 7 | 1 |
| HMM | 0 | n/a |
| . . . | . . . | . . . |

Another important feature of the Model Building Interface 104 is that it could be used to invoke processes in Model Building Module 205, by passing the selected machine learning algorithm from previous step in process 204 and triggering the pre-built routines in a programming library to dynamically generate a layout for Predictive Analytics model. Feature selection can be carried out through interface elements in interface 104, while hyperparameter values as configuration variables can be passed as parameters to the methods in module 205. Once the model features and parameters are configured using interface 104 and module 205, the finalized model can be saved into Model Repository 403. Encryption can be used to secure the model definitions in non-human readable format, which has advantages for industries and applications that require extra layer of data security.

Next step after Model has been built is to select a Training Data Set. The Data Selector Module 206 is used to identify and separate training data from test data with the help of data selection feature in interface 102. The training data set is then supplied via Train Model interface 105 to the Model Training Module 207. The process within Model Training Module 207 uses the feature identification to label datapoints for example, as in a classification or clustering machine learning algorithm. During training process, the model learns patterns and relationships in the data to make predictions or decisions about new, unseen data.

Once enough datapoints have been used that comprise training data set, the model is subjected to evaluation using the Evaluate Model interface 106 and Model Evaluation process 208. The purpose of model evaluation process is to make sure that model is operating as effectively in carrying out the task of predicting as it is expected to be. So, after training the model, it's essential to evaluate its performance using a separate validation dataset or through cross-validation techniques, which involves analyzing the model's performance metrics (for example, precision, recall, accuracy, F1-score for classification tasks etc.) to assess its effectiveness in solving the task at hand. The evaluation process using interface 106 and module 208 assists in identifying potential issues such as overfitting or underfitting and guides decisions regarding model selection, feature engineering and hyperparameter tuning etc. One aspect of model evaluation is model tuning, where a careful calibration of normalization weights can be used in an iterative fashion for ensemble models where the model comprises of more than one machine learning algorithm, to determine which of those have the most predictive power. For example, if the Predictive Analytics model uses 3 algorithms (SVM, KNN, Naïve Bayes), there may be a combination of normalization weights that may yield the optimal outcome and accuracy of predictions. The Framework proposes automation by initiating simultaneous worker threads (light weight processes) to run on special purpose computer servers (Infrastructure layer 400), where the worker threads compute a score of predictive accuracy by iteratively adjusting weights for individual algorithms within an ensemble model. The benefit of this approach is that it reduces manual effort which would otherwise require trial and error and several man hours.

Once the model's performance has been evaluated and optimized, the next step is to test its performance on a separate dataset that was not used during training or evaluation. This model testing process is carried out using Test Model interface component 107 and Model Test Module 209. Testing serves as a final check to assess how well the model generalizes to new, unseen data and to estimate its performance in real-world scenarios. The test dataset provides an independent sample to validate the model's performance and ensure that it meets the desired criteria.

The advantage of using this sequence of steps of training, evaluating, and then testing the predictive analytics model, is that the user can build and validate a robust and effective model that performs well on unseen data. This iterative process of training, evaluation, and testing is fundamental to the development of reliable machine learning based predictive analytics solutions; however, the Framework introduces automation of evaluation process which reduces the time it takes to finalize the model for testing and improves overall performance and efficiency. Test Results are maintained in Results Repository 404 for review and further tuning by the user.

Deploy Model interface 108 is used together with the Model Deployment Module 210 to dynamically select and recommend an optimal Virtual Machine (VM) server option for selected machine learning algorithm type and size of datapoints.

This feature of Model Deployment Module 210 within the Framework is explained with an example below, where specific pre-configured machine types (not generic computers) are available as options to implement and deploy the Predictive Analytics models. Based on the number of datapoints to be processed during training, testing, evaluation and ultimately deployment to Production systems, the machine type is recommended to the user. This enhances the user experience and reduces reliance on specialized knowledge typically retained by a Platform specialist who would otherwise manually inspect elements of data set to determine which machine configuration would be most optimal for a given scenario. The advantage of this approach is to reduce the cost by only using resources that are necessary to train, test and deploy the model for a given data size. This results in benefit to the business implementing Predictive Analytics through cost savings by using appropriately configured server and not necessarily an oversized server like a Premium machine, that would cost more per use than a Standard or Basic one.

Consider a concrete example below for the selection of Server Type or worker machine, given the algorithm that has been selected (Decision Tree) and various input data size (data points), and corresponding computational complexity required.

| | | Computational Resources | | Server |
|---|---|---|---|---|
| | Number of | (CPU and Memory | | (Machine) |
| Algorithm | Datapoints | Requirements) | | Type |
| Decision | Less than 10k | Low | 8 MHz | Basic |
| Tree | | | 32 GB | |
| Decision | Greater than 10k | Moderate | 16 MHz | Standard |
| Tree | but less than 100k | | 64 GB | |
| Decision | Greater than 100k | High | 32 MHz | Premium |
| Tree | But less than 500k | | 256 GB | |
| Decision | Greater than 500k | Very High | 64 MHz | Platinum |
| Tree | | | 512 GB | |

Using above method or structure, a machine type or a server is recommended and selected for training the machine learning model. Note that the VM will be special purpose server computer that will be hosted in Cloud to provide infrastructure redundancy and scalability, this is illustrated in Infrastructure layer 500. The various VMs are indicated as 501, 502, 503 and 504 in FIG. 1.

The purpose of processes in Worker Machine Scheduler Module 211 is to reduce the uptime of Cloud VMs (501 to 504), and to reduce the costs associated with operating pay per use schedule. When machines are not in use, they can be brought offline programmatically, the constructs of which are well understood and do not need further explanation here. However, the Framework goes one step further, as it monitors the server activity and allocates or deallocates only the non-Production VMs dynamically if they are not being used. The benefit of this approach is that no manual intervention is required, with an added advantage of no specialized personnel needing to be available to change configuration of the Virtual Machine or server computer being used. It should be noted that this is different from when a machine is selected, the auto-scaling feature within a certain Cloud Computing vendor offering may upgrade or downgrade memory resources to accommodate optimal performance within that session. This feature would be independent of the Worker Machine Scheduler Module 211, where the process only monitors and brings the VM offline or online depending on time of the day or usage.

The processes within Model Repository Management Module 212 provide a mechanism for maintaining the Predictive Analytics Models, that have been finalized, tested and saved in the Model Repository 403. The process does that by allowing a power user to grant security access through user roles to the Model Repository, so the Predictive Models are only accessible to the trusted users with pre-defined roles such as Model Viewer, Contributor, Administrator etc. It also allows for Models to be archived or deleted if the model efficacy has reduced and model needs to be retired. All user actions are logged in the Results and Log Repository 404. The benefit of having such role-based security access is that it provides compliance with regulatory requirements for certain industries and businesses where user control and security is important. The user interface element that invokes processes in Model Repository Management 212 could be found under Maintenance option in Build Model interface 104.

Model Efficiency Analyzer Module 213 has a process that evaluates model efficacy over time to determine if predictive score is becoming worst overtime for a given Predictive Analytics Model that has been in use for over a certain period. Model Review is scheduled to be automatically performed at a pre-determined period, for example every quarter or six months or annually, depending on the needs of business. If the efficacy of model drops below a certain threshold, for example less than 75% accuracy, then model can be retired, and the user has the option to do so from the Maintenance control within Build Model interface 104.

The Outlier Datapoints Analyzer Module 214 can be invoked by the Model Builder Interface 104 as well, where the process identifies if certain anomalous data, also known as outlier datapoints, is the result of faulty sensor data or a false positive. The outlier analysis is performed on the data that was filtered during pre-processing step in Pre-process Data Interface 102. Further investigation can be carried out using methods reserved for anomaly detection which are well understood and described in contemporary studies.

Automated Database Tuning Module 215 comprises processes for rebuilding index, database statistics and other optimization techniques that would normally be carried out manually by a database administrator. These methods are well understood and documented, but the Framework automates them through an automated job scheduler, to improve the performance of data storage and retrieval.

Smart Graph Generator Module 216 works with Explore Data interface 101 to automatically detect data features and suggest the type of graphical representation most suitable for the data set, for example number of dimensional attributes and measures could determine which graph type to use to display data (e.g. bar chart, pie chart, scatter plot etc.).

The Data Visualization Layer 300a completes first embodiment of the Framework by providing output interface elements, which for this embodiment consist of display systems only. These display systems are used to generate dashboards, reports, email alerts and otherwise produce visual and graphical output for the users to be able to view the predictive results in real and non-real time. The display systems include but are not limited to Monitors and Mobile handheld devices etc.

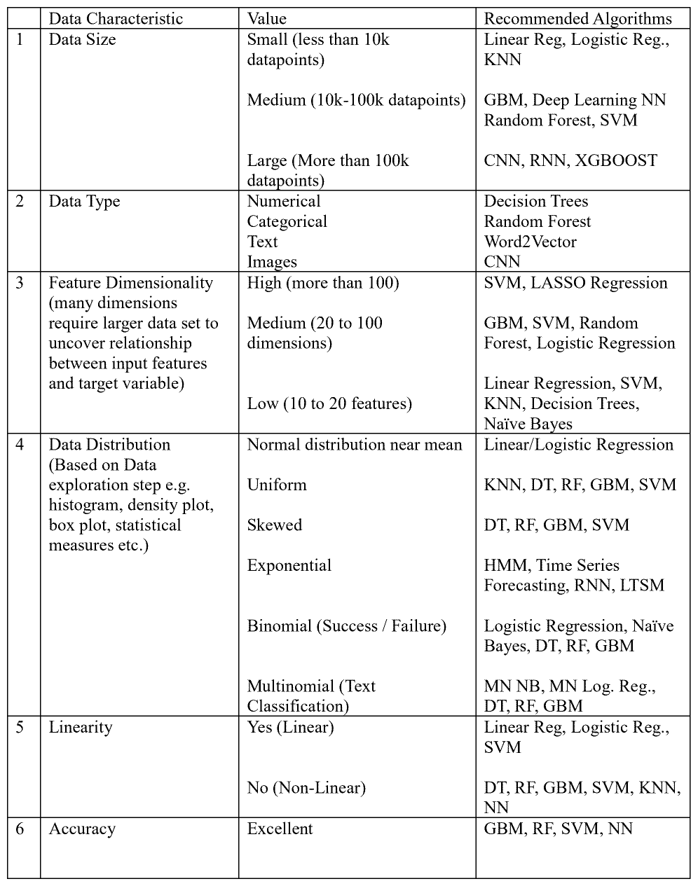

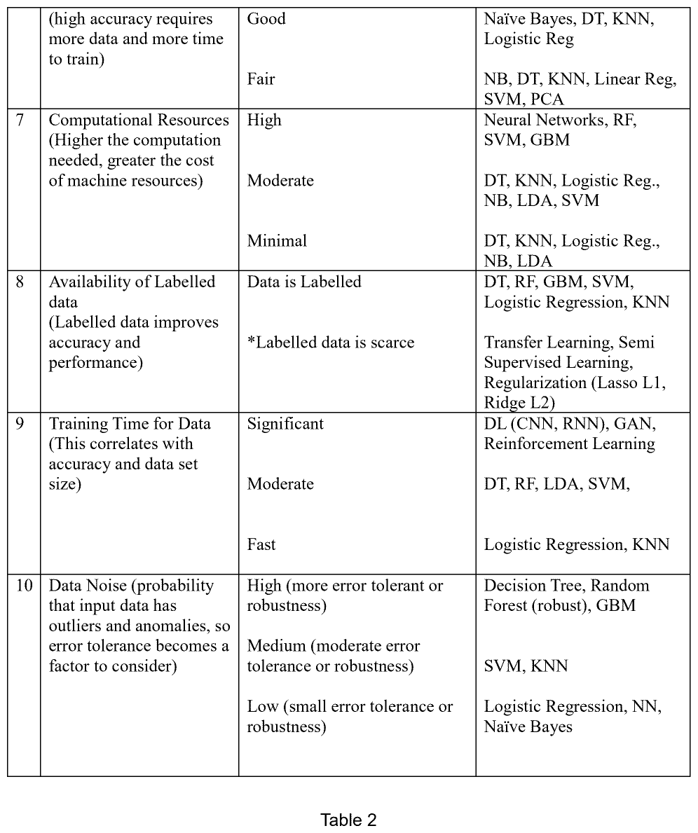

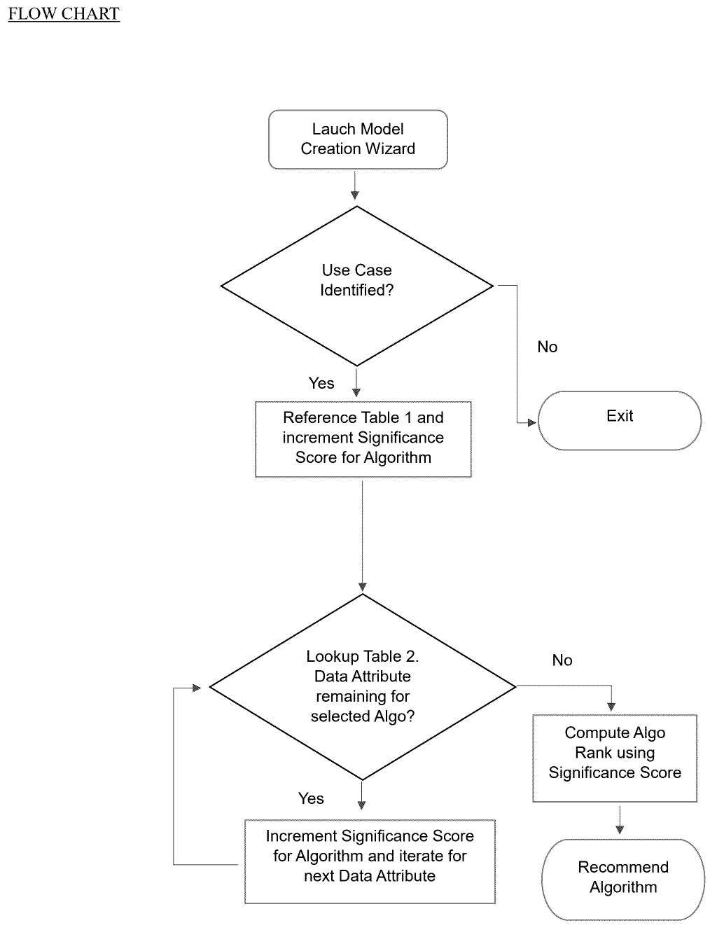

The second embodiment as illustrated in FIG. 2 is identical to embodiment 1, however the Data Visualization layer 300b consists of Single Board Computers (SBC). These SBC components are embedded special purpose computers that have the capability to act in real time on an event of interest, in response to the predictive value generated by the Predictive Analytics model. This may include but is not limited to sending a signal to a remote sensor to actuate and perform some tasks in real time. This real time behaviour of Single Board Computers, which are widely available commercially, can benefit many applications for relaying information to utility systems, power systems, robotic systems etc. The interface between the Framework and SBCs is typically done through Wi-Fi, sockets or other protocols that are widely used in industry.

The third embodiment of the Framework as illustrated in FIG. 3 is identical to first embodiment, except that the Data Visualization layer 300c now consists of both Display systems and SBCs. In this arrangement, the Display systems can be used to allow users to control the trigger of an event through SBCs, by observing the predictive value and alert on display systems. This provides a mechanism for human control or supervision of an otherwise real time system, which may be desirable for certain applications and industries where a decision is made through human oversight and not through pre-programmed automated event handler.

The are several advantages of the embodiments of the Framework presented above. One of the advantages is improved User Experience through the eight interfaces described in User Interface Layer, which together form the basis of an intuitive Graphical User Interface (GUI). It should be noted that there can be variations in how the GUI is implemented, whether through a web-based application or windows desktop application. Nevertheless, the features described above are equally applicable regardless of the technology chosen to implement them.

Another advantage is the improved usability because the Framework is business user focused, interface is user friendly which lends itself to Lean Agile Project implementation methodology. The User-friendly interface has wrapper methods that call the underlying processes by passing them required and optional parameter values. This way the business user can focus on building the model without having to know the exact details of the programming language working in the background. For example, dragging and dropping a “Create New Model” would launch a wizard style dialog prompt that takes the user through a series of questions and builds the model in background based on responses provided by the user. The programming libraries working in the background interact with data in the database and incoming stream or real time data to predict compare with historical data, compute score and probability of a match, and return the results to user interface. This way, the business user does not need to write any programming code themselves if they are not familiar with any of the programming languages.

Yet another advantage of the Framework is cost effectiveness as it reduces the overall cost of implementation through automation of processes. By automatically selecting machine learning algorithm that would prove to be most optimal through Significance score and Algo-Rank method detailed earlier, the cost is reduced by avoiding trial and error runs of various machine learning algorithms before finding the one that produces optimal results. Further, by dynamically selecting Cloud based Virtual Machine (VM) Server based on data size etc. and machine learning algorithm type for training, testing, evaluating and deploying a Predictive Analytics Model, the cost savings can be realized. By allocating and deallocating worker machine in non-Production environments during down time through automation scripts is yet another avenue for cost savings.

The Framework thus introduces various elements of creating efficiency because it utilizes automation to optimize operations and is oriented towards creating efficiencies within individual processes. The overall effect is to enhance user experience, increase speed of training models and reduce costs through automation.

There are several industries and market sectors where this Framework can be employed for practical use. For example, Asset intensive industries such as Utilities, and Oil and Gas can benefit from predictive maintenance of assets by getting timely alerts if a particular asset sends datapoints that signify degradation of equipment or asset.

Disaster Management is another area that can benefit by providing sensor and IoT data such as that the Predictive Analytic models built using the Framework proposed here, would process data collected from rainfall gauges, river levels and soil moisture sensors to predict when and where floods are likely to occur. AI driven flood modeling can help design better infrastructure and urban planning to reduce flood risk and damage.

Another industry to benefit from using this Framework is Financial Services and Banking, where the Predictive Analytics Models can be used to detect Money Laundering Fraud Detection, which directly affects national financial security by exposing banks and other financial institutions to reputational and financial losses as well as possibility of institutional failure. This also indirectly affects taxpayers if the institutions being affected decide to recoup financial losses by raising fees on financial products.

Yet another industry to benefit is Insurance Industry, where Predictive Analytics Models can be used for Fraudulent Claims detection. By using the proposed Framework for building predictive analytics models, the insurance companies in market sectors such as automotive, life, casualty and property etc. can stand to benefit by detecting fraudulent patterns and stopping them from causing financial or reputational losses.

Similarly, HealthCare is another industry where cardiovascular diseases and Cancer cell diagnosis can benefit from Predictive modeling to detect elements of disease earlier, which in turn would allow the patient to receive timely and directed treatment. Other healthcare industries to benefit from using this Framework include drug discovery and development, where predictive modeling can be used to provide data driven insights during various stages of drug development such as lead compound identification, clinical trial design, target identification and validation etc.

Transportation is another market sector where this Framework for Predictive Analytics could be used to quickly create models that identify traffic patterns and predict congestion areas in peak and off-peak hours. The decisions could then be made to ease the traffic congestion or to design smart cities by taking steps for avoiding traffic congestion through residential areas at peak times etc.

Defence Sector and Robotics is an area where Framework can be used to predict certain outcomes in real time, for example solider health monitoring on battlefield, identifying foe vs friend and decoy objects on battlefield, could all benefit from using an intuitive Framework for Predictive Analytics. Similarly, in the field of autonomous robots, especially the mobile robots mapping geography of unseen terrain, predictive modelling can be used to identify objects and map the terrain.

Manufacturing is another industry where preventive maintenance of machines in a manufacturing environment such as an assembly line could benefit from using this Framework.

While providing the specifications for the processes in the Framework presented with the help of three embodiments, the applicant seeks protection on any patentable feature or part of the invention. The components, interfaces, modules, parts and processes presented in the Framework can manifest in the order different from show in figures.

The terms “comprising” and “consisting of” as used in the claims and description does not exclude other elements or steps. The term “a” or “an” as used in the claims and description does not exclude plurality. A process, module or interface recited in the claims may fulfill the functions of several processes, modules or interfaces recited in the claims.

1. A Framework for developing, training and deploying machine learning based Predictive Analytics models for real time and non-real time applications.

2. A Framework as described in claim 1 comprising:
(a) a collection of processes and methods for user interaction, input data collection including real time or static input data and data pre-processing;
(b) a collection of processes and methods for model development, training and deployment using special purpose preconfigured cloud hosted computers, known as servers;
(c) a collection of processes and methods for data processing, data storage and data output to a visualization device for a practical application;
(d) processes and methods for data processing, data storage and data output using special purpose bespoke single board computers for real time predictive action in response to an event of interest for a real-time practical application.

3. A Framework as described in claim 1 comprising:
(a) a proprietary method to select most optimal machine learning algorithm with greatest possible predictive ability;
(b) a component that provides automation process for calibration of normalization weights to be used in training machine learning algorithms for an ensemble Predictive Analytics model;
(c) a component that provides automation process for selection of a server type for training and deployment based on input data characteristics and machine learning algorithm(s) in real time;
(d) a component that provides automation process for generation of visual elements including graphs and charts based on input data characteristics such as measures and dimensional values in real time;
(e) a component that provides automation for scheduling special purpose worker machines or servers to reduce cost of operation.
